(19) United States
(12) Patent Application Publication
(10) Pub. No.: US 2004/0088217 A1
(43) Pub. Date: May 6, 2004

(54) Systems and methods for providing family educational play and social centers with rotatable advertising and sponsorship

(76) Inventor: J. Brad Knight, Park City, UT (US)

Correspondence Address: Michael F. Krieger, Kirton & McConkie, 1800 Eagle Gate Tower, 60 East South Temple, Salt Lake City, UT, 84111, US

(21) Appl. No.: 10/286,488

(22) Filed: Nov. 1, 2002

(51) Int. Cl. G09B 9/00; G09B 19/00; A63B 69/00; G06F 17/60

(52) U.S. Cl. 705/14; 434/247

(57) ABSTRACT

Systems and methods for providing advertising in a public educational system configured for children. Revenue is generated by selling advertising space within the system. The advertising space takes the form of, but is not limited to, letters (“C” is for car and is sponsored by the Larry Anderson Pontiac dealership), three-dimensional modular elements, (“H” is for house where a play house element is sponsored by a real estate agent Guy Haslem), large iconic three-dimensional features (“P” is for the Indiana Pacers with a large basketball icon), or the co-sponsorship of the theme and/or the location. Sponsorship supports the costs of the education zone equipment, location in shopping center, and maintenance of the location, as well as a remunerating and profiting investors and owners. Accordingly, the education zone provides a method for advertising by allowing businesses to sponsor different modular elements. The cost of sponsorship depends on the size and/or utility of the sponsored item. A simple character such as a letter will cost less than a large icon, which will cost less than co-branding the entire education zone.

### BACKGROUND

1. Field of the Invention

The present invention relates to systems and methods for advertising and sponsorship. In particular, the present invention relates to providing advertising in a public educational system that is configured for interaction of children.

2. Background and Related Art

Public access gathering areas, such as parks, are typically located in communities to provide opportunities for individuals and families to interact and play together. The public parks traditionally include playgrounds, open recreational space, and other facilities (e.g., baseball diamonds) for particular sports activities. However, due to time constraints on individuals and families and the inconvenience of having to travel to a park, many individuals are unable to spend much time at the public parks. As a result, many parents and children do not have an opportunity to spend as much time together as they desire.

Thus, while facilities currently exist that provide a location for families and individuals to interact and play together, time constraints inhibit their use. Accordingly, it would be an improvement in the art to augment or even replace current facilities with alternative facilities, systems, and/or techniques that are more accessible and convenient for modern families.

### SUMMARY AND OBJECTS OF THE INVENTION

It is an object of the present invention to provide modular elements that are easily attached and removed from a floor covering located in a mall so as to facilitate the exchange of such elements with similar elements in other mall locations, or exchange them with new elements to accommodate themes and sponsors.

It is another object of the present invention to provide means for advertising to business entities, whereby an entity receives advertising space located on a modular play element and/or displays product literature/coupons and/or questionnaires, wherein the size of the element roughly corresponds to the amount of the entity's financial contribution.

Additional objects and advantages of the invention will be set forth in the description that follows and in part will be obvious from the description or may be learned by the practice of the invention. The objects and advantages of the invention may be realized and obtained by means of the instruments and combination particularly pointed out in the appenended claims.

To achieve the foregoing objects, and in accordance with the invention as described herein, an education zone is located in a public location, such as a shopping center or mall. The present invention provides seating that surrounds the education zone. By utilizing space in a mall or shopping center, the present invention allows adults to consolidate personal and parental responsibilities by enabling parents to spend time playing with and educating their children while shopping and taking care of other errands. In addition, the seating area allows adults to interact with each other while tending to their children.

According to one aspect of the present invention, the education zone and its elements compliment the surrounding store fronts, as well as the center in which it is located, by mirroring the aesthetic design of the surrounding architecture.

In one embodiment of the present invention, a library of children's books is included the education zone. The seating area enables parents and children to read and interact with each other, thereby providing parents an opportunity to both educate their children and foster the parent/child relationship.

In another aspect of the present invention, the education zone may utilize a theme wherein letters, elements, shapes or objects relate to that theme. For example, where the theme is “Under the Sea,” whales, buried treasure, or sharks may be represented in connection with the letters W, T, and S, respectively. In one embodiment, the theme centers on a local landmark, where the landmark is represented in connection with an appropriate letter.

According to another aspect of the present invention, the modular elements comprise blocks or other objects in the shape of a letter. The letter-shaped block may include features of an object beginning with the letter. For example, the letter “A” block might incorporate the shape of an apple, or the letter “Z” block may have a zipper superimposed on its face. Several spaces on the floor contain a letter that corresponds to a particular block. The present invention teaches that children will become acquainted with letters by matching a certain letter block with the corresponding letter on the floor, or by associating the letter on the block with the familiar object incorporated into or represented in connection with the letter block. Thus, through playful activities children may increase and sharpen their reading skills and ability.

According to another aspect of the present invention, revenue is generated by selling advertising space within the education zone. This advertising space may take the form of, but is not limited to, letters (“C” is for car and is sponsored by the Larry Anderson Pontiac dealership), three-dimensional modular elements, (“H” is for house where a play house modular element is sponsored by real estate agent Guy Haslem), and large iconic three-dimensional features (“P” is for the Indiana Pacers with a large basketball icon). In addition, a particular modular element or other advertising space may be co-sponsored, and the theme and mode of advertising altered accordingly. The money obtained by virtue of such sponsorship will likely suffice to cover the costs of supplying education zone equipment, costs associated with renting space for the education zone in the shopping mall, and costs associated with maintaining the education zone. Any surplus capital may be used to remunerate and profit investors and owners.

While the methods and processes of the present invention have proven to be particularly useful in the applications described above, those skilled in the art can appreciate that the methods and processes can be used in a variety of different applications and in a variety of different areas of manufacture to provide advertising in a publicly accessible system that is configured to facilitate the education of children and the interaction of children and their parents.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DECRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a representative embodiment of an education zone in a mall corridor where the perimeter of the education zone is defined by a small wall, and where representative seating faces the open center;

FIG. 2 illustrates a top planar view of a representative education zone floor grid;

FIG. 3 illustrates a top planar view of a representative education zone perimeter;

FIG. 4A illustrates a cross-sectional view of the representative seating;

FIG. 4B illustrates a front view of the representative seating;

FIG. 5A illustrates a cross-sectional view of a representative trash can facade;

FIG. 5B illustrates a front view of a representative trash can facade;

FIG. 5C illustrates a top view of a representative trash can facade;

FIG. 6A illustrates a planar view of representative decorations;

FIG. 6B illustrates a top sectional view of the representative decorations;

FIG. 6C illustrates a front elevational view of the representative decorations;

FIG. 6D illustrates a cross-sectional view of representative decorations;

FIG. 7A illustrates a cross-sectional view of a representative trash can facade, such as that in FIG. 5A, that is configured to adjoin a book shelf;

FIG. 7B illustrates a front view of a representative trash can facade, such as that in FIG. 5B, that is configured to adjoin a book shelf;

FIG. 7C illustrates a top view of a representative trash can facade, such as that depicted by FIG. 5C, that is configured to adjoin a book shelf;

FIG. 8A illustrates a cross-sectional view of representative seating along a book shelf;

FIG. 8B illustrates a front view of the representative seating of FIG. 8A;

FIG. 9A illustrates a cross-sectional view of representative bookshelves in a library portion of the education zone;

FIG. 9B illustrates a front view of the bookshelves in the library of the education zone;

FIG. 9C illustrates a side view of the bookshelves in the library of the education zone;

FIG. 10A illustrates a cross-sectional view of a representative diaper changing area with a trash can facade attached;

FIG. 10B illustrates a front view of the diaper changing area with a trash can facade attached;

FIG. 10C illustrates a planar view of the diaper changing area with a trash can facade attached;

FIG. 11A illustrates a cross-sectional view of a representative shoe holder/cubbyhole beneath representative seating;

FIG. 11B illustrates a front view of the shoe holder/cubbyhole areas;

FIG. 12A illustrates a cross-sectional view of a representative entrance fixture;

FIG. 12B illustrates a planar sectional view of the entrance fixture;

FIG. 12C illustrates a planar view of the entrance fixture;

FIG. 13 is a front elevational view of an alternate embodiment of the education zone of FIG. 1; and

FIG. 14 is a top view of the alternate embodiment of FIG. 13.

### DETAILED DESCRIPTION OF THE PREFERRED EMBODIMENTS

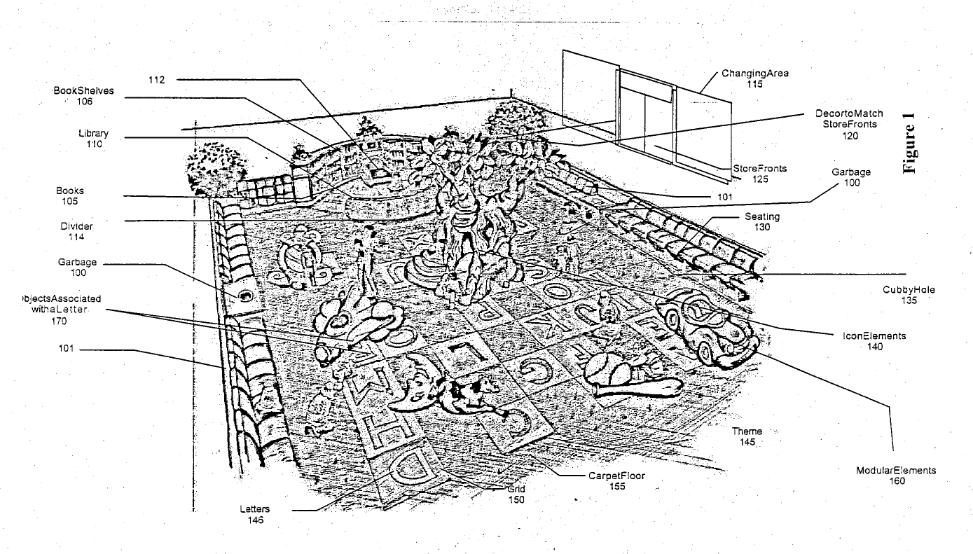

The present invention relates to systems and methods for providing an educational and social zone for children and adults to interact. FIG. 1 illustrates the present invention as used by a number of children and adults. The inside perimeter 101 of the education zone is lined with seating 130 periodically interrupted by a trash can facade 100. The trash can facades are discussed in more detail below.

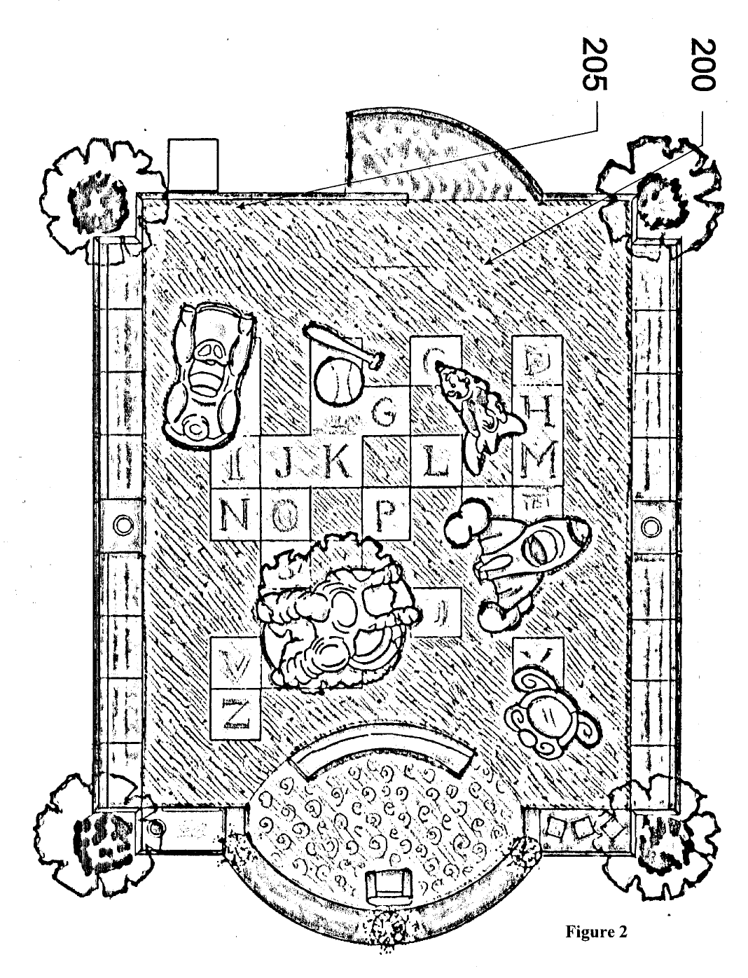

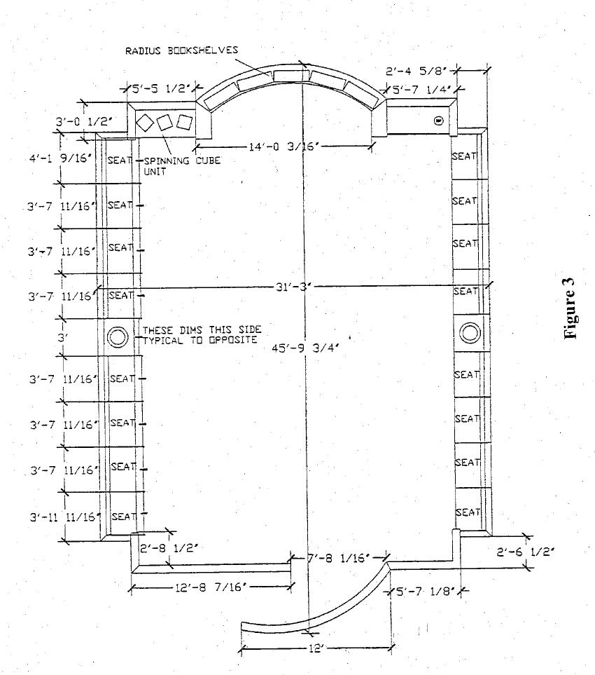

For security purposes there is only one entrance 200, as shown in FIGS. 2 and 3. With reference to FIG. 2, a single entrance 200 is located at one corner of the education zone. A single entrance is preferable since limiting the number of entrances increases security, as strangers are unable to pass through the education zone, and as the effort required for parents to tend to their children while the children play and learn is reduced.

Décor complementing the aesthetic look of the surrounding business facades adorns the education zone's perimeter 101. Such congruence between the education zone décor and the décor of the surrounding stores is likely to appeal to both parents and children alike. Indeed, such congruence is likely to evoke parents' respect for the quality of materials and academic purpose of the education zone, while creating a fun yet academic atmosphere for children.

The floor of the education zone is comprised of a loop carpet 155, wherein a grid pattern 150 is incorporated into the carpet. Alphanumeric letters 151 are integrated within several squares of the grid, and images or objects may be superimposed on or in connection with the letters 170. The carpet design helps children become familiar with alphanumeric characters and with the words they represent as the children play and interact with the letters and their associated shapes and objects integrated into the carpet design.

On the floor are several modular elements including three-dimensional blocks 165, three-dimensional iconic elements 140, and three-dimensional letters 166 that increase children's familiarity with individual letters and the sounds they make. Each modular element 160 has a step-like hook side coupled to the side of the modular element to releasably and non-destructively attach to the loop carpet 155. The present invention teaches modular elements 160 that remain coupled to the loop carpet 155 while the children play and learn, but that may be easily removed when desired.

To further aid parents in their efforts to educate their children, one embodiment of the present invention teaches an education zone that focuses on a theme 145 in which the letters integrated into the carpet design are associated with words familiar to the theme. The modular elements 160 also correlate with the theme.

Businesses may sponsor an element at a price, where the price depends on the size and utility of the element. For example, the least expensive mode of sponsorship may consist of advertising in connection with a single iconic letter. A sponsorship progression schedule may be implemented to provide more significant advertising opportunities depending on the amount of money dedicated to the project, ranging from sponsorship of an iconic element as discussed above, to perhaps co-branding the education zone. Such a framework enables progressive advertising opportunities to businesses while, in turn, providing a mechanism by which to finance, maintain, and profit the education zone.

Again referencing FIG. 2, opposite the entrance 200 is a library area 110 with additional seating 112 and a partition 114 to separate the education zone from the reading area. The partition also serves to maintain a quiet educational atmosphere in the reading area. The library also includes bookshelves 106 filled with books 105.

FIG. 3 depicts a planar view of the education zone and the location of features within the zone of the preferred embodiment. Those skilled in the art will appreciate that the location of the features as well as the dimensions of the zone are illustrative and are not intended to limit the scope of the invention. One factor affecting the size of the zone is the host shopping center's available space. In addition, some embodiments of the present invention teach the presence of a library, which, if added, demands more space than embodiments without such.

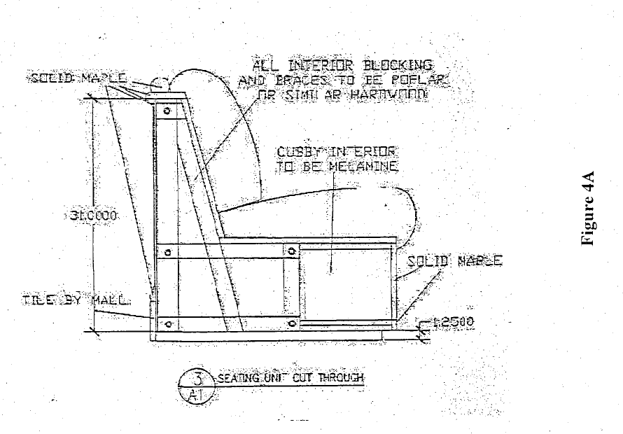

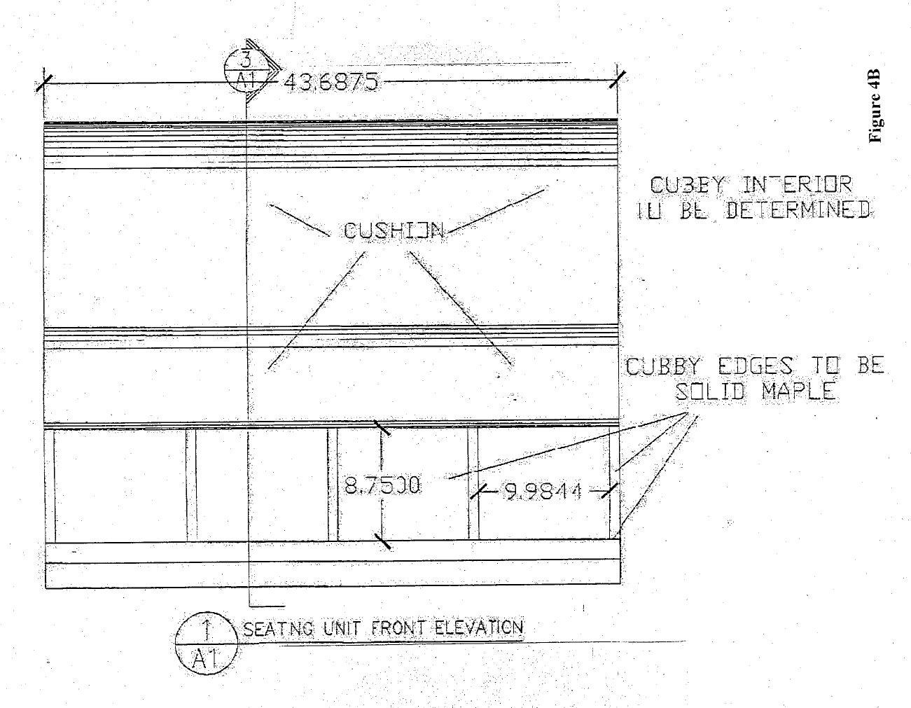

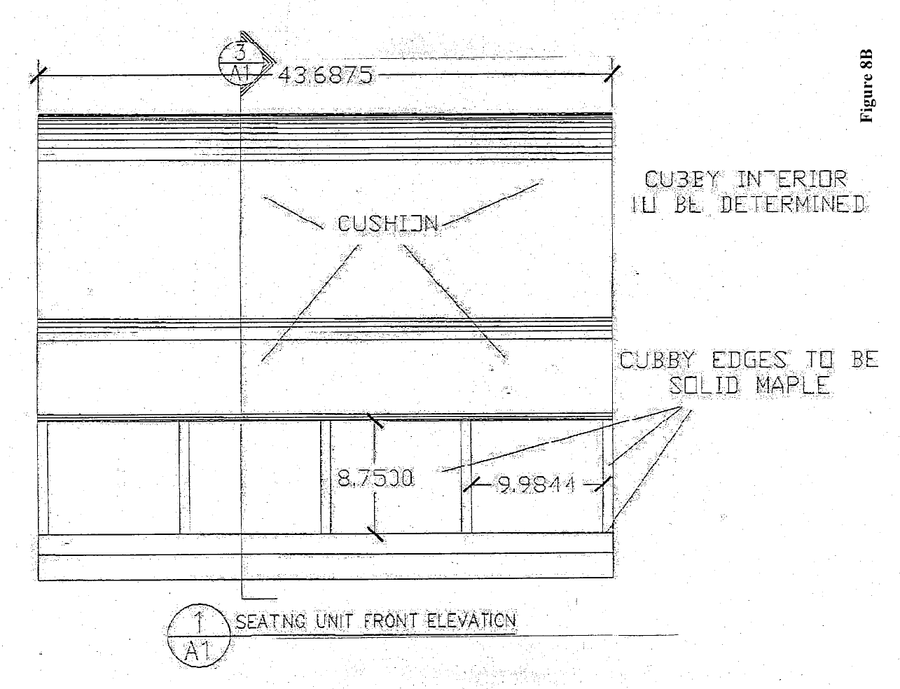

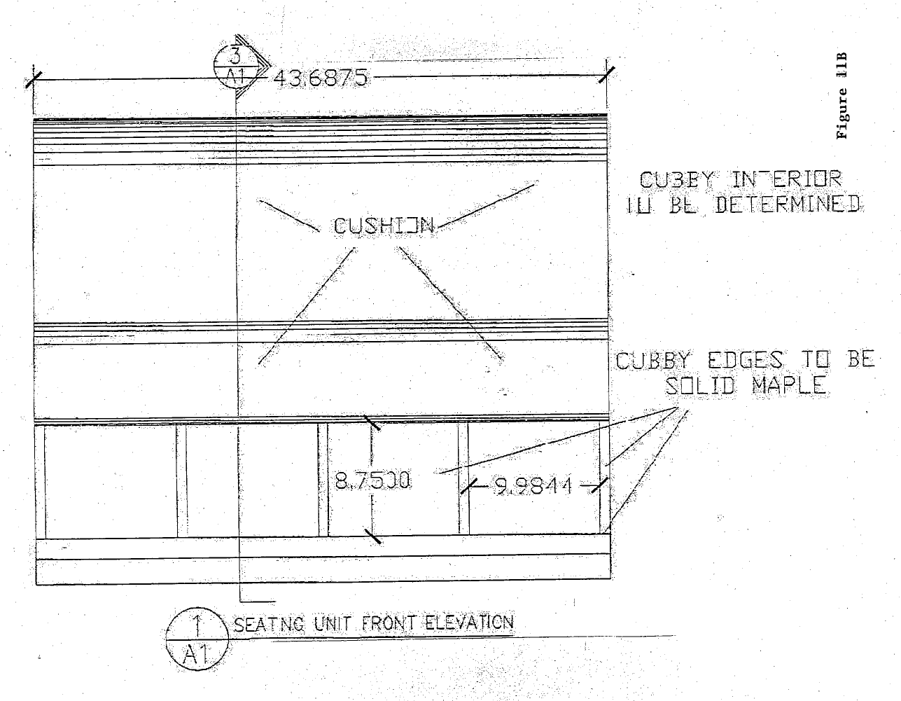

FIGS. 4, 8 and 11 illustrate a perimeter arrangement including seating that faces the interior of the education zone as well as a wall that separates the education zone from the mall. The seating is designed for adults and children to sit individually, or together in small groups, reading, resting, and/or socializing. The area directly beneath the seats functions as a cubbyhole space for shoes and other items that patrons may bring with them. Those skilled in the art will appreciate the variety of configurations and systems that may be utilized to establish the perimeter. In all embodiments, however, the perimeter provides seating for patrons, a boundary between the education zone and the mall, and storage space for small items.

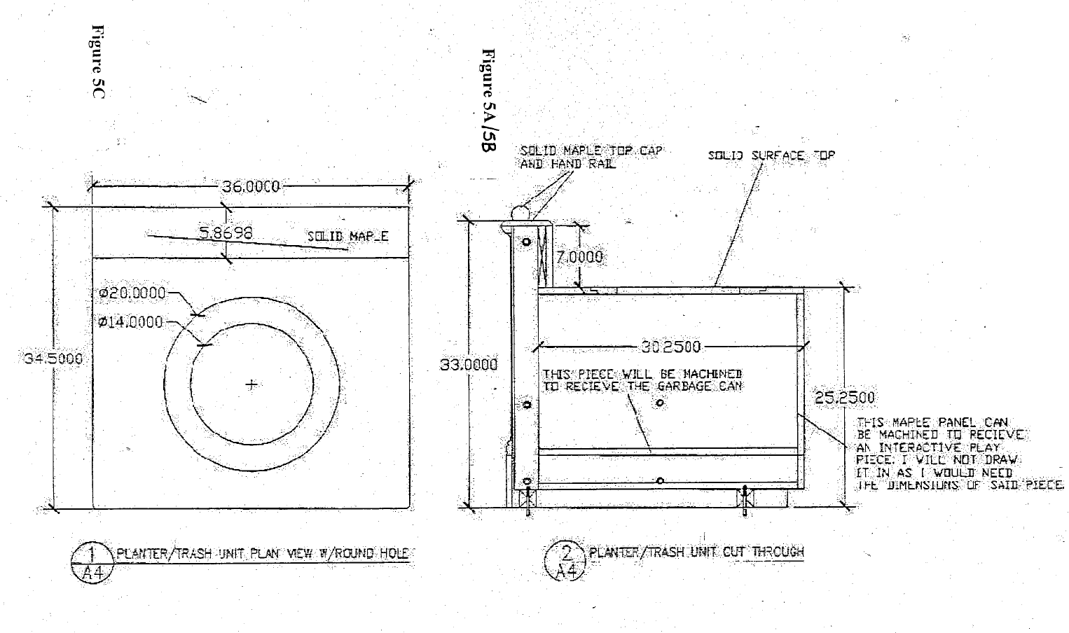

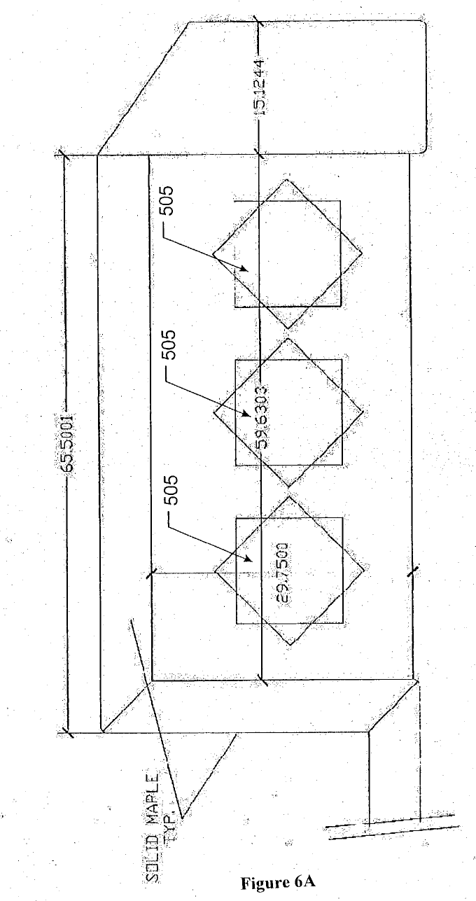

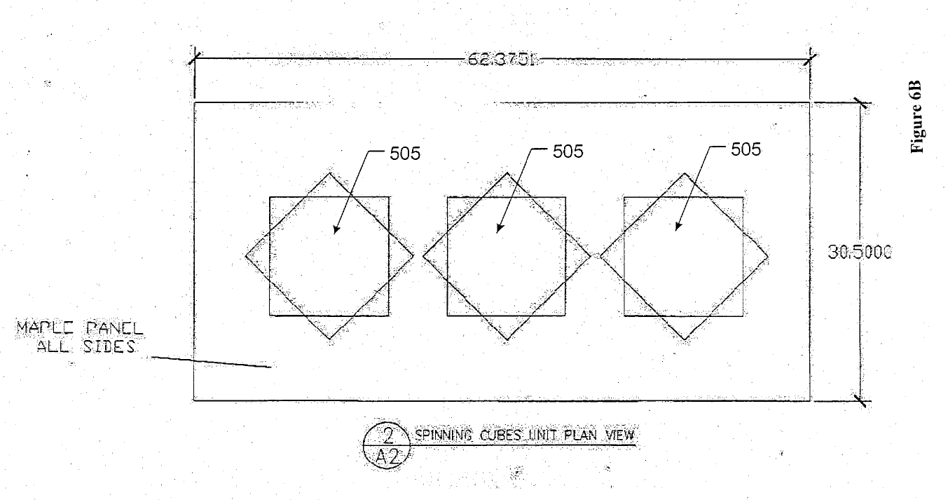

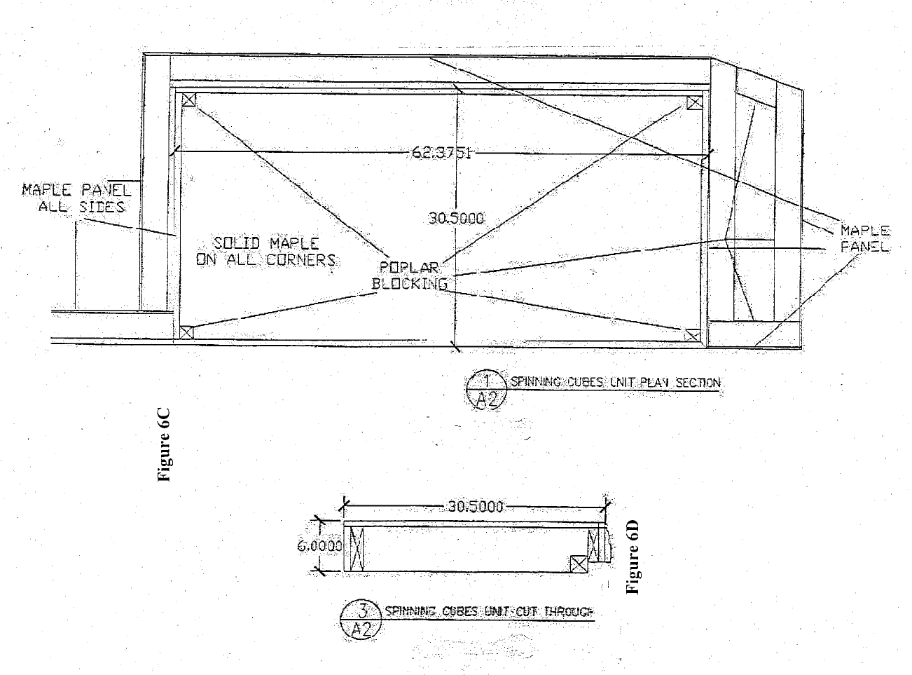

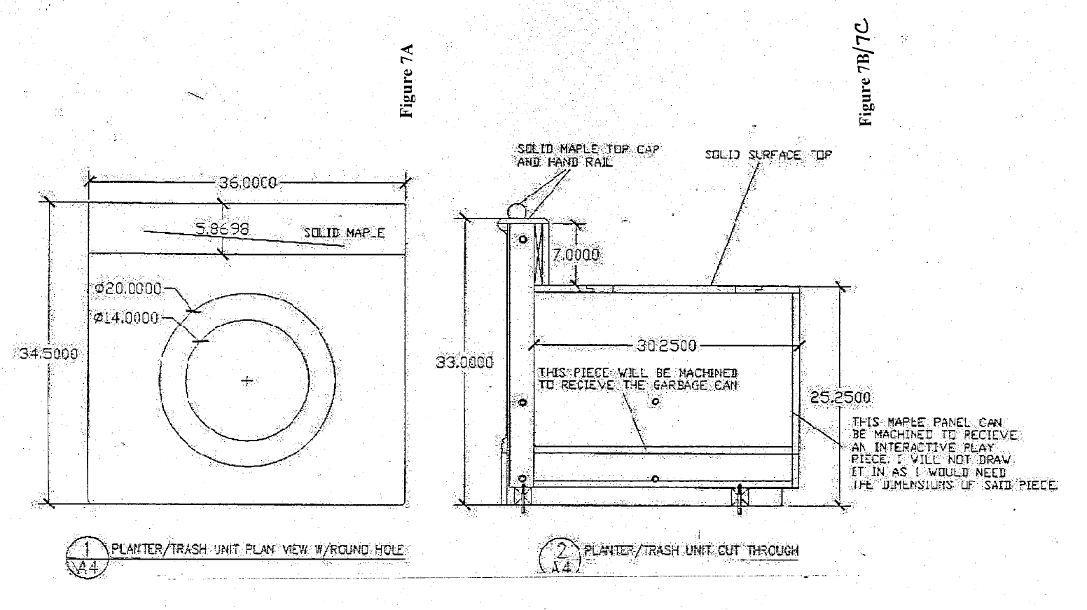

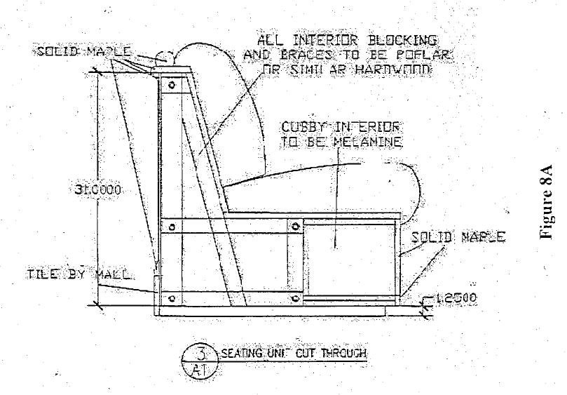

FIGS. 5 and 7 show sections of the perimeter designed for trash disposal. Trash cans are provided to preserve a clean and respectful atmosphere within the education zone. As shown in FIG. 5A, the trash disposal system provides a space between the outer and inner walls of the perimeter to house a trash can. FIG. 5C depicts a planar view of the counter top with an octagonal hole cut in the counter top. The garbage can sits below the hole, thereby enabling a patron to simply and easily drop garbage into the can. While the illustrative hole is octagonal, those skilled in the art will appreciate that a circular, square, or other shaped hole of appropriate dimensions would perform an equivalent function.

The present invention teaches that the decor 505 should complement the surrounding storefronts, thereby creating a quality atmosphere and aesthetically appealing environment. As shown in FIG. 5, the ornaments should be of such a quality and character that the education zone will fit tastefully within the mall environment. The ornamentation shown in FIG. 5 is meant only as an example and not a limitation, and may be changed depending on the existing surrounding decor.

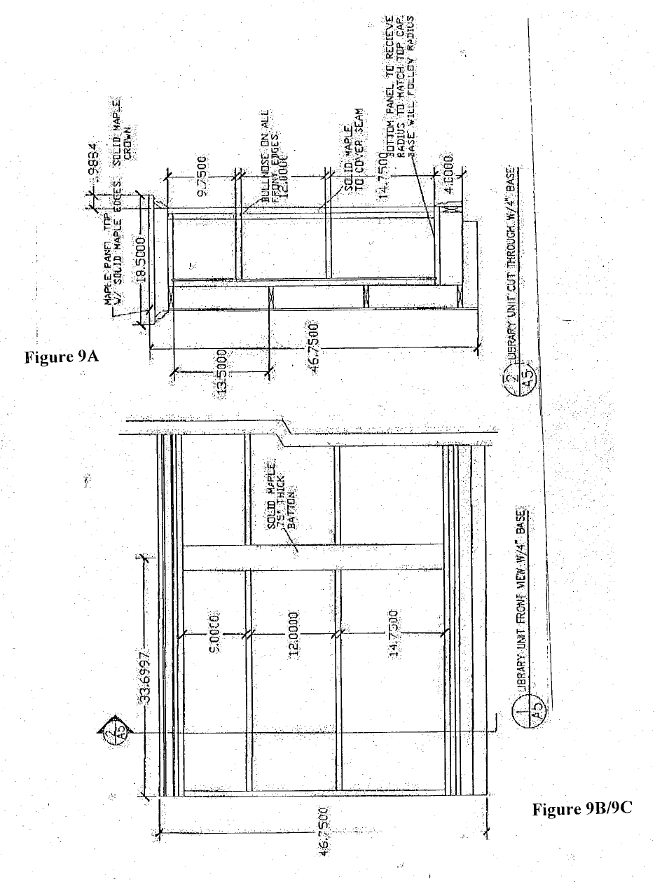

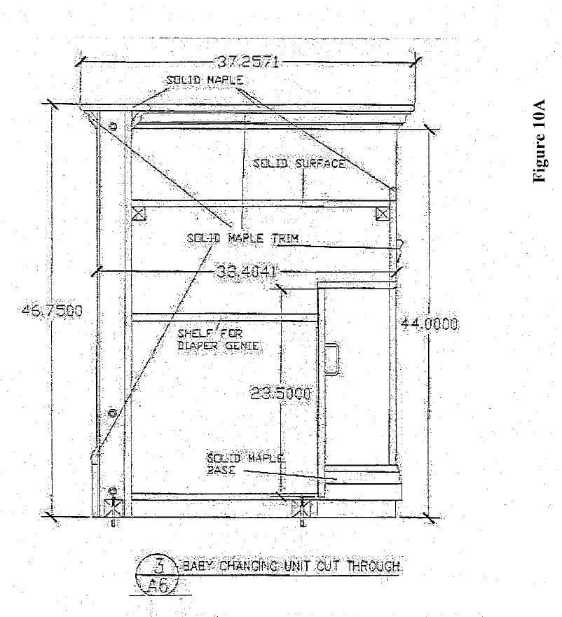

FIG. 9 illustrates bookshelves 106 that may be used to shelve the books 105 in the library portion 110 of the education zone. It is envisioned that the books will be children's books and the shelves will be accessible to young children.

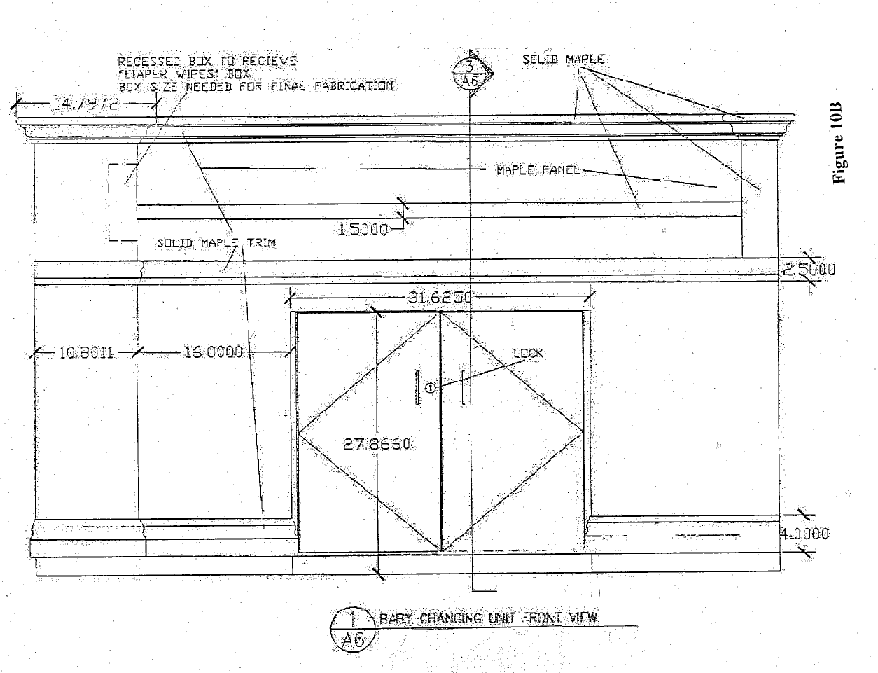

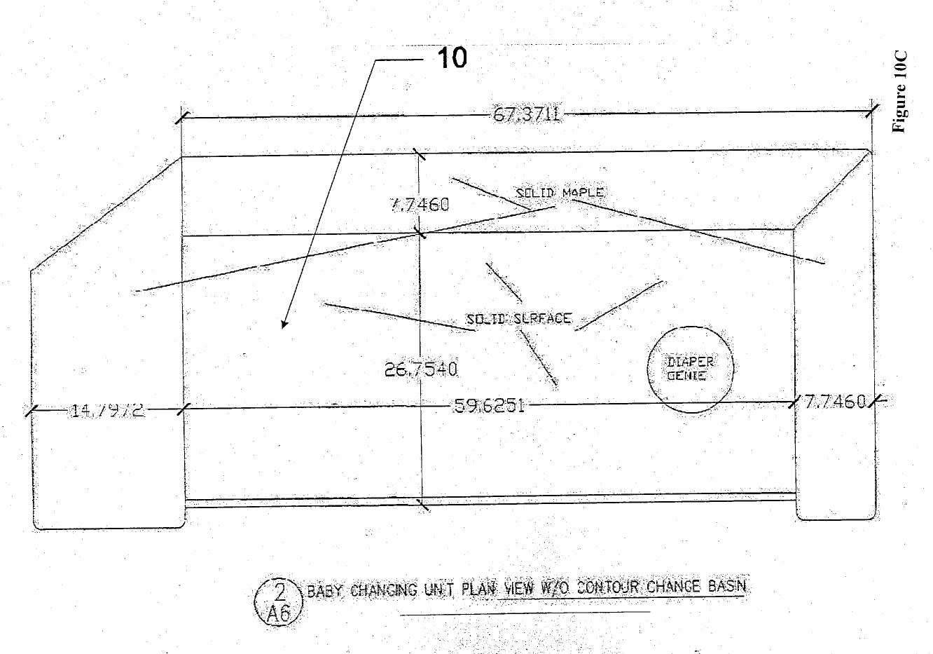

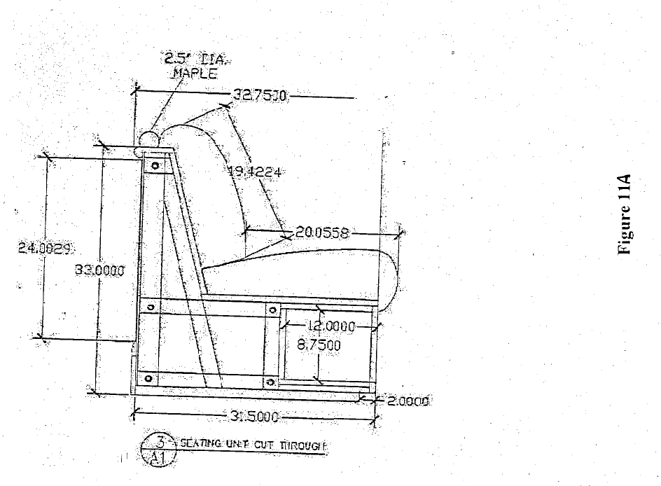

FIG. 10 teaches that a diaper changing station 115 will be provided to allow for the necessities of childcare and to make young families feel more welcome. As shown in FIG. 10A, a changing table is coupled to the exterior perimeter. FIG. 10C shows a trash disposal system conveniently positioned next to the changing table to allow for easy disposal of diapers or other waste.

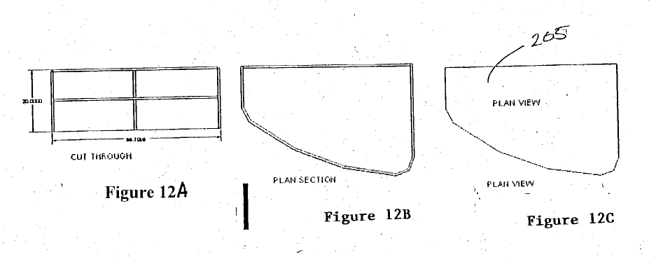

FIG. 12 shows an entrance fixture that signals the entrance to those in the mall and the exit to present patrons of the education zone.

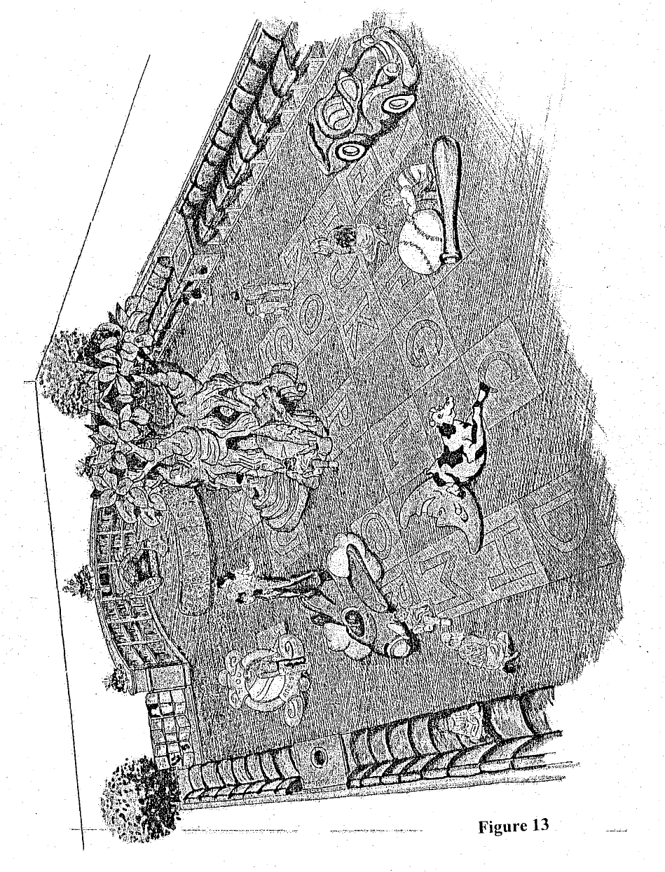

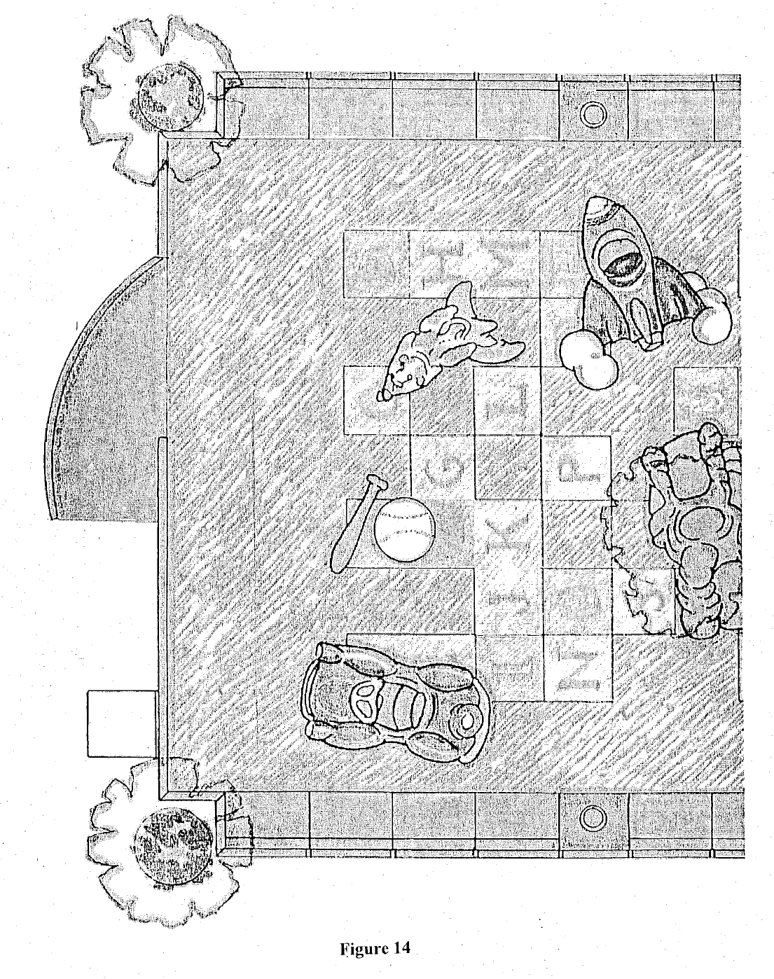

FIGS. 13 and 14 illustrate another presently preferred embodiment of the present invention, wherein life-like modular elements beginning with a particular letter of the alphabet are placed next to the corresponding letter alphabet incorporated into the carpet design. Such alternative modular elements are implemented in place of the previous embodiment's three-dimensional blocks and iconic elements that are literal representations of alphanumeric characters.

The embodiment of FIGS. 13 and 14 encourages children to associate every day objects with letters of the alphabet, in addition to increasing their familiarity with letters generally. For example, a fabricated play tree house may be placed on the carpet next to the letter “T.” Likewise, a mirror with the word “You” etched on its frame may reside on the carpet next to the letter “Y,” and a larger than life three-dimensional baseball and bat may be integrated into the carpet grid containing the letter “B.” In this way, children are exposed not only to individual letters of the alphabet by virtue of their incorporation into the carpet design, but also to the words and objects such letters represent. In addition, by utilizing every day objects already familiar to children in conjunction with the relatively new concept of alphanumeric characters and their uses, children may more easily associate each letter with an associated object, thereby facilitating their long-term skill development.

What is claimed is:

1. In a system configured for child recreation, a method for advertising comprising the steps of:
providing a recreational system configured for children, wherein said recreational system includes at least one modular element;
enabling purchase of advertising space within said recreational system, wherein a sale of said advertising space comprises sponsorship of at least one of said modular elements; and
allowing children to play in and on said recreational system and said modular elements.

2. The method recited in claim 1, wherein a cost associated with said sponsorship of one of said modular elements corresponds to a size of said modular element.

3. The method of claim 1, wherein a cost associated with said sponsorship of one of said modular elements corresponds to a level of utility of said modular element.

4. The method of claim 1, wherein said modular element is a three dimensional block.

5. The method of claim 1, wherein said modular element is an iconic element.

6. The method of claim 1, wherein said modular element is a three-dimensional letter.

7. The method of claim 1, wherein said modular element is a three-dimensional object corresponding to a letter of the alphabet.
